(19) United States
(12) Patent Application Publication
(10) Pub. No.: US 2015/0227445 A1
(43) Pub. Date: Aug. 13, 2015

(54) SYSTEMS AND METHODS FOR CORRELATING BATTERY POWER DRAW AND EVENTS IN BATTERY-OPERATED COMPUTING DEVICES

(71) Applicants: Simon Arscott, San Francisco, CA (US); Sameer Nanda, San Jose, CA (US)

(72) Inventors: Simon Arscott, San Francisco, CA (US); Sameer Nanda, San Jose, CA (US)

(73) Assignee: GOOGLE INC., Mountain View, CA (US)

(21) Appl. No.: 13/453,397

(22) Filed: Apr. 23, 2012

(51) Int. Cl. G06F 11/30; G06F 1/26

(52) U.S. Cl. CPC G06F 11/3062; G06F 1/26; G06F 11/3065

(57) ABSTRACT

A battery-operated computing device collects data on battery power draw, and logs events and user actions occurring during device operation. A time profile or graph of the battery power draw is displayed on the computing device. The displayed time profile or graph of battery power draw is overlaid with markers or indicators of the logged events or user actions to highlight power hogging events or actions.

### TECHNICAL FIELD

This description generally relates to the monitoring and prediction of power usage by electronic gadgets or appliances. In particular the description relates to monitoring and prediction of power usage based upon actual use of the electronic gadgets or appliances in the field.

### BACKGROUND

Electronic gadgets or appliances (e.g., computers, tablet computers, personal digital assistants (PDAs), mobile phones, multimedia players, etc.) are ubiquitous in the contemporary world. Exploiting advances in microelectronic circuit miniaturization and telecommunications, and the pervasive availability of the Internet, modern electronic gadgets or appliances increasingly have multiple functions or perform multiple tasks. For example, a mobile phone may feature a camera function and a traditional phone function. A “smartphone” may further include a web browser or e-mail application with wireless access to the Internet. An Internet tablet may feature an MP3 and video player, a web browser, a chat application and a picture viewer. In general, a modern electronic gadget or appliance may integrate one or more features of a desktop computer, for example, a display, a keyboard, a pointing device (a touchpad, also known as a track pad, and/or a pointing stick) and speakers into a single unit. For convenience in description, a modern electronic gadget or appliance may be referred to herein as “a computing device” even if its primary purpose or use is for other than traditional computing. Thus, any electronic gadget or appliance (e.g., a laptop computer, a digital camera, PDA, a mobile phone, a multimedia player, etc.) may be commonly referred to herein as “a computing device.”

Generally, manufacturers highlight the low system resource usage of their electronic gadgets or appliances. For example, laptops, tablets, etc. often tout the amount of time the device may operate with a fully charged battery (e.g., 7 hours of video playing time, 8 hours of cellular talk time, 250 hours of standby time, etc.). Likewise, product reviewers (e.g., magazine writers, newspaper writers, etc.) typically devote a portion of their product reviews to the way the reviewed product (e.g., laptop, tablets, smartphone, etc.) consumes system resources. These reviews often compare the marketing claims of the product manufacturers to the actual usage results experienced by the product reviewer. Also, users often rely upon the product's prediction (e.g., via a low battery warning, a monitoring application, etc.) of how much system resources are left or how long the existing system resources are expected to last.

In this context, the term “system resources” may refer to the resources (e.g., electrical power stored in a battery, an amount of network bandwidth available, storage space, etc.) that a device or system uses to operate and perform various functions or fulfill user requests. Often one or more of these system resources may be consumed in a non-linear fashion. For example with Lithium-Ion (Li-ion) batteries, typically the rate of change in the electrical charge increases as the amount of the electrical charge in the battery decreases. Or, stated another way, the Li-ion battery depletes faster the less charged up the battery is, such that the time to go from 100% charged to 90% charged is longer than to go from 20% charged to 10% charged.

Generally, the manufacture's official system resource consumption rates are generated using an artificial testing environment. In such an artificial environment, the device-under-test (DUT) is placed in a laboratory and subjected to a set of benchmark tests. These benchmark tests are typically artificial or synthetic tests that simulate a device usage level based upon an arbitrary or artificial usage scenario. For example, the common “video battery drain test” used by product reviewers to test battery usage, simply plays a video file over and over until the battery is drained. This “video battery drain test” is often used to measure battery usage or consumption despite the fact that a typical user generally would not play the same video repeatedly and exclusively (i.e., without any other interaction with the device) until the device's battery was drained or depleted. Nevertheless, such synthetic system resource usage tests are frequently employed to measure system resource consumption and also used to generate system resource prediction models (e.g., how many minutes until the battery is expected to be drained, etc.).

In the field, electronic gadgets or appliances may be used under varying conditions that are different from the artificial testing environment. This results in varying power consumption profiles for the electronic gadgets or appliances in use. An electronic gadget or appliance that runs on stored power (e.g., rechargeable batteries) can run out of power inopportunely during use due to weak or drained batteries. To avoid disruption in use due to weak or drained batteries, common electronic gadgets or appliances (e.g. laptops, mobile phones, digital cameras, and other portable gadgets) often include battery monitoring circuits. These battery monitoring circuits can provide a user with information on state of charge (SOC) of the battery in the electronic product or gadget.

Such information may enable the user to prophylactically recharge batteries in an attempt to avoid power disruption during future use of the electronic product or gadget, but does not remove the variability in the time-to-empty of the batteries and attendant risk of power disruption due to varying conditions of use.

Consideration is now being given to ways of enabling users to actively manage power usage by electronic gadgets or appliances between battery recharging events. In particular, attention is directed to enabling users to actively manage power usage by gadgets or appliances that are capable of performing multiple tasks either serially or in parallel.

### SUMMARY

According to one general aspect, a battery-operated computing device with a local display includes a processor, and a power draw/interesting events overlay generator, which is configured to correlate changes in battery power draw with events or user actions that occur in the operation of the computing device. The overlay generator may be configured to display a time profile or graph of the battery power draw and overlay the displayed power draw profile or graph with indicators or markers of one or more events or actions that occurred during the operation of the computing device. The overlaid power draw profile displayed may be designed to highlight events or actions that caused significant changes in battery power draw (e.g., increases above a threshold percent).

The battery-operated computing device includes a battery power draw monitor configured to provide a time profile of battery power draw during the operation of the computing device, and an event logger configured to record and time-stamp events and/or user actions occurring in the operation of the computing device. The event logger may be programmed to record and time-stamp one or more selected events or actions (e.g. opening or closing of tabs in a web browser, navigating to or away for a particular website, pop-ups, starting or stopping audio, starting or stopping audio, transitions between 3G, Wi-Fi, or Ethernet communications, user-triggered or automatic display brightness circuitry responses to ambient light changes, keystrokes, and/or activation or closing of applications, etc.)

In another general aspect, in the context of a battery-operated computing device, a method incudes collecting data on battery power draw occurring during operation of the computing device, and logging events and user actions that occur in the operation of the computing device. The method further includes displaying a time profile or graph of the battery power draw occurring during operation of the computing device, and overlaying the displayed time profile or graph of the battery power draw with indicators of one or more of the logged events or user actions that occurred during the operation the computing device.

In another general aspect, a system includes a server configured to receive (e.g., via the Internet) battery power draw data, and time-stamped records of events and actions from one or more battery-operated computing devices (e.g., a laptop or tablet computer, a digital camera, a personal digital assistant, a mobile phone, a smartphone, and/or a multimedia player) that are in field use. The system further includes an analyzer configured to analyze and correlate battery power draw data with one or more of the events and actions that occurred at the one or more battery-operated computing devices in field use. The analyzer may be configured to analyze the effects of a selected event or action (e.g., access of particular web page, or activation of a particular application) on the battery power draw by a battery-operated computing device in field use.

In yet another general aspect, a method includes establishing communication links (e.g., web links) from a central location (e.g., from a computer or server) to one or more battery-operated computing devices that are in field use, and collecting data on battery power draw and time-stamped records of events and actions that occurred at the computing devices in field use. The method further includes analyzing the data to correlate changes in battery power draw with events and actions occurring at the computing devices. The method may include analyzing the effects of a selected event or action (e.g., access of particular web page or activation of a particular application by a computing device in field use) on battery power draw.

Features and details of one or more implementations of the foregoing aspects are set forth in the accompanying drawings and the description below. Other features will be apparent from the description and drawings, and from the claims.

### BRIEF DESCRIPTION OF THE DRAWINGS

FIG. 1 is a block diagram illustrating an example computing device, in accordance with the principles of the aspects described herein.

FIG. 2 is a schematic example of a battery power draw profile that may be displayed on the computing device. The battery power draw profile is overlaid with indicators of one or more events or actions that occurred during the operation of the computing device, in accordance with the principles of the aspects described herein.

FIG. 3 is a flowchart illustrating an example method for displaying to a user a computing device's power draw profile marked with indicators of interesting events that occur in operation or use of the computer device, in accordance with the principles of the aspects described herein.

FIG. 4 is a block diagram illustrating an example system for correlating changes in power draw with events or user actions occurring in the field operation of one or more computing devices, in accordance with of the principles of aspects described herein.

FIG. 5 is a flowchart illustrating an example method for correlating changes in power draw with events or user actions occurring in the operation of one or more computing devices, in accordance with of the principles of aspects described herein.

FIG. 6 shows an example computer device and an example mobile computer device that can be used to implement the aspects described herein.

Like reference symbols in the various drawings indicate like elements.

### DETAILED DESCRIPTION

An example computing device described herein may be powered by mains electricity (e.g., via an AC adapter). Alternatively or additionally, the computing device may be used away from a mains outlet using a rechargeable battery. The computing device may include battery monitoring circuits to measure, for example, a state of charge (SOC) of the battery in the computing device at a particular time. Further, the computing device may include an indicator or display of a state of charge (SOC) of the battery. The computing device may, for example, include a self-updating battery icon display that provides a measure of state of charge (SOC) of a battery at any given time.

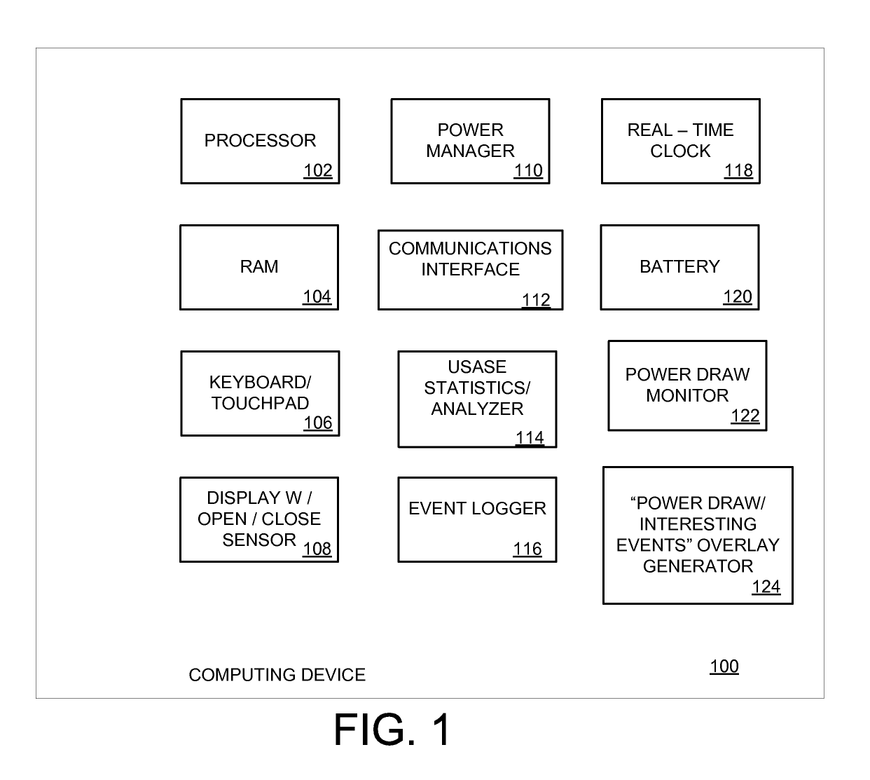

FIG. 1 shows an example computing device 100 in accordance with the principles of the aspects described herein. Computing device 100 includes a number of modules, components and/or devices (e.g., a processor 102, a RAM 104, a keyboard/touchpad 106, a display 108, a power manager 110, a communications interface 112, a usage statistics/analyzer 114, an event logger 116, a real-time clock 118, a battery 120, a battery power draw monitor 122, and a power draw/interesting events overlay generator 124).

It will be appreciated that specific modules, components and/or devices (hereinafter “elements”) are shown in FIG. 1 only for purposes of illustration and are listed only by way of example. In various implementations, computing device 100 may include fewer elements, additional elements or substitute elements. Further, the various elements in computing device 100 may be operationally coupled with one another in any of a number of appropriate manners. For instance, processor 102 of computing device 100 may be operationally coupled with one or more of the other elements of the computing device 100 using a bus, or multiple busses. As another example, power manager 110 of computing device 100 may be coupled to processor 102, battery 120, display 108, and other appropriate elements of computing device 100 for carrying out power management activities in computing device 100. Additionally, two or more of these elements may be fully or partially merged into a single element. For example, power manager 110 and usage statistics/analyzer 114 may be implemented as a single module in computing device 100. In other implementations, a single element of computing device 100 may be implemented as multiple elements, or may include multiple sub-elements. For instance, battery 120 may be implemented using multiple elements, for example, a battery and a separate battery alarm module. The particular number, types and arrangement of elements in a computing device will depend on the specific implementation.

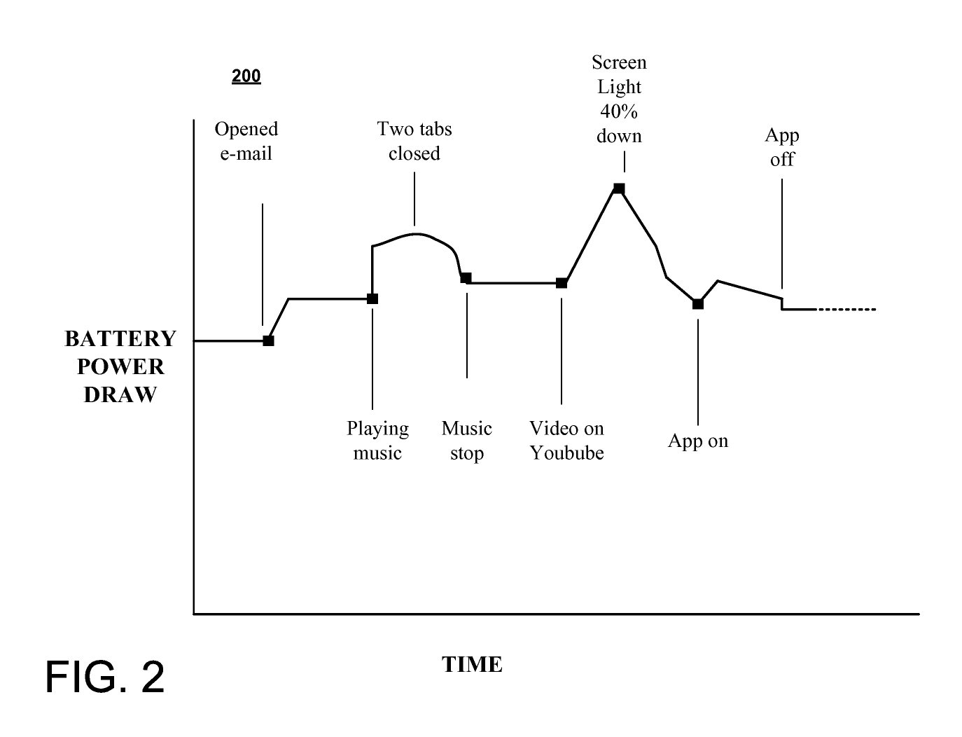

In computing device 100, power draw/interesting events overlay generator 124 may be coupled to battery power draw monitor 122 and event logger 116. Overlay generator 124 may be configured to correlate changes in battery power draw with events or user actions in the operation of computing device 100 based on data obtained, for example, from battery power draw monitor 122 and event logger 116. Overlay generator 124 may be further configured to present locally, for example, on display 108, to a user a time profile or graph of battery power draw by the device during its operation or use. Overlay generator 124 may be further configured to mark, label or otherwise overlay the displayed battery power draw profile or graph with indicators of interesting events or user actions occurring during the operation of computing device 100 by a user. Such an overlaid time profile or graph of battery power draw may be designed to highlight or quickly bring to a computing device user's attention, events or actions that may have caused noticeable or significant increases in battery power draw. The overlaid time profile or graph of battery power draw also may be designed to highlight events or actions that may have failed to cause noticeable or significant increases in battery power draw during the operation of computing device 100 by a user. FIG. 2 shows a schematic example of a battery power draw profile 200 that may be displayed on the computing device. Example battery power draw profile 200 is overlaid with indicators of one or more events or actions (e.g., opening e-mail, closing tabs, playing a video, playing music, screen light adjustment, app on and app off, etc.) that occurred during the operation of the computing device.

Battery power draw monitor 122, which may provide power draw data to overlay generator 124, may include any suitable circuitry for measuring or sampling power draw by computing device 100 in its operation. Battery power draw monitor 122 may, for example, include battery monitoring circuits that estimate the state of charge of battery 120 by voltage measurements, current integration and/or other suitable technique. The battery monitoring circuits in computing device 100 may be user-programmable. In specific implementations or instances of computing device 100, the battery monitoring circuits may be programmed to measure power draw continuously or to sample power draw periodically at a selected rate (e.g., every two seconds or less) as may be suitable for display.

Event logger 116, which may provide interesting events data to overlay generator 124, may be configured to monitor or receive information about events occurring throughout computing device 100. The events may include computer tasks, application initiated actions and/or user initiated actions during operation of the computing device. For convenience in description, computer tasks, application initiated actions and/or user initiated actions, collectively or individually, may be referred to herein as “events” or “events and/or actions.” Event logger 116 may be programmed to record and time-stamp selected “interesting” events or actions. The selected events or actions may, for example, include one or more events such as the opening or closing of tabs in a web browser, navigating to or away for a particular website, pop-ups, starting or stopping audio, starting or stopping audio, transitions between 3G, Wi-Fi, or Ethernet communications, user-triggered or automatic display brightness circuitry responses to ambient light changes, particular keystrokes, and/or activation or closing of particular applications (apps). The particular apps selected as interesting events may, for example, include apps for e-mail, managing schedule, making video calls, backing up the computing device, ad-supported apps, etc. A particular app selected as an interesting event may be user-selected. A user (e.g., a web developer), instead of merely relying on testing in a controlled or laboratory test environment, may desire to test the effect of newly developed app on battery power draw on the computing device in an uncontrolled or real use environment. Such a user or a web developer may, for example, designate the newly developed app as an interesting event for event logger 116 to record and time-stamp with a view of testing the effect of the newly developed app on battery power draw on the computing device in real use in the presence of other computing device processes.

Overlay generator 124 may be configured to mark, label or otherwise overlay the displayed battery power draw profile or graph with indicators for all of the events recorded and time-stamped by event logger 116. Alternatively, generator 124 may be configured to mark, label or otherwise overlay the displayed battery power draw profile or graph only with indicators for the events that cause a significant change (e.g., 10% or more change) in power draw. The overlay of the battery power draw profile or graph with indicators of interesting events or user actions by overlay generator 124 may be configured or designed to allow users to self-diagnose battery behavior and identify events or applications that are power hogs draining battery 120 in the operation of computing device 100. The overlay may provide users such as web developers with an understanding of power draw from their developed web sites.

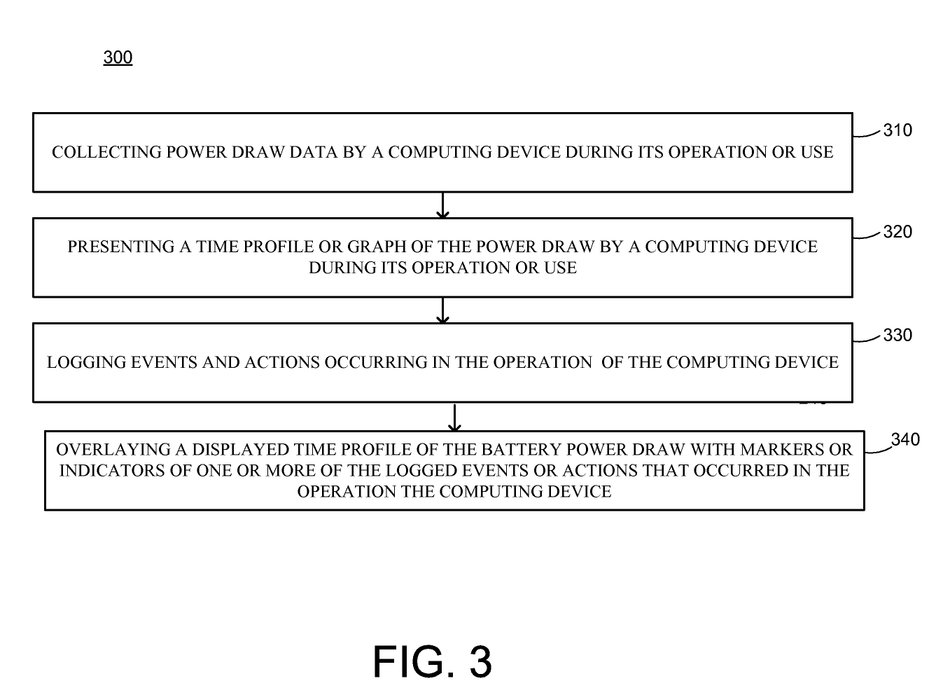

FIG. 3 is a flowchart showing an example method 300 for displaying a computing device's power draw profile marked with indicators of interesting events that occur in operation or use of the computer device. Method 300 illustrated in FIG. 3 may be implemented in computing device 100 of FIG. 1. Accordingly, description of method 300 herein may include references to computing device 100 of FIG. 1. However, it will be appreciated that method 300 may be implemented in other computing device configurations and that method 300 is not limited to computing device 100 or the specific arrangement of computing device 100 that is described herein with reference to FIG. 1.

Method 300, as shown in FIG. 3, includes collecting battery power draw data (310) and presenting a time profile or graph of the battery power draw by a computing device during its operation or use (320). Method 300 further includes logging “interesting” events and user actions occurring in the operation or use of the computing device (330) and overlaying the displayed power draw profile or graph with markers or indicators of interesting events or user actions that occurred in the operation the computing device (340).

In method 300, collecting battery power draw data 310 may involve using a battery power draw monitor (e.g., power draw monitor 122 in computing device 100) to continuously measure or periodically sample the battery power draw at a suitable rate for display (e.g., every two seconds). Presenting the time profile or graph of the battery power draw 320 may involve displaying the time profile or graph on a local display (e.g., display 108 in computing device 100).

Further in method 300, logging interesting events and actions occurring in the operation or use of the computing device 330 may involve use of an event logger (e.g., event logger 116 in computing device 100) to record and time-stamp selected interesting events or actions occurring in the operation or use of the computing device.

With renewed reference to FIG. 1, in addition to or as an alternate to providing a local display of the correlation of battery power draw with events or user actions, computing device 100 may be configured to report the correlation to a remote device (e.g., a web server). Additionally or alternately, computing device 100 may be configured to report uncorrelated data (i.e., battery power draw data and a log of events and action) to the remote device.

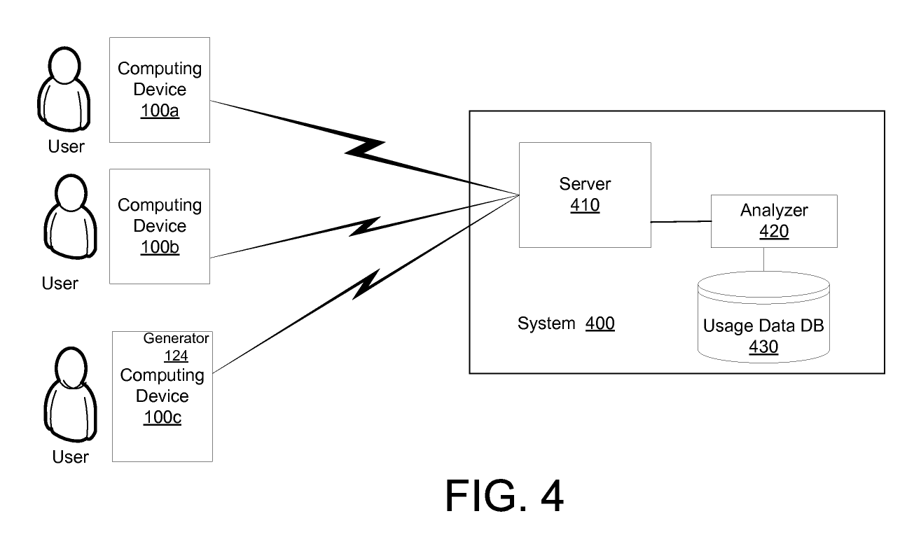

FIG. 4 shows an example system 400 for correlating battery power draw with events or user actions occurring in the operation of one or more computing devices (e.g., computing devices 100a, 100b, and 100c) that are deployed in uncontrolled or real use environments. in accordance with of the principles of aspects described herein. System 400 includes a server 410, which may, for example, be coupled to, an analyzer 420 and a usage database 430. Server 410 may, for example, be a web server or other server that is communicatively linked to one or more of the computing devices 100a, 100b, 100c that that are deployed in uncontrolled or real use environments.

Computing devices 100a, 100b, 100c (e.g., laptops, netbooks, tablets, smartphones, etc.) that can be communicatively linked to server 410 may be configured, like computing device 100 (FIG. 1), to include battery power draw monitors that can provide time profiles of battery usage. The computing devices 100a, 100b, 100c may also be configured to include elements (e.g., event logger 116) which record and time-stamp events or actions. A computing device 100a, 100b, 100c may also optionally include an element like generator 124 of computing device 100, which overlays time profiles of battery usage with markers or indicators of “interesting” events for local display.

Server 410 may be configured to collect data from each computing device 100 with which it is communicatively linked. In particular, server 410 may be configured to collect time profiles of battery power usage and time-stamped records or logs of events or actions from one or more computing devices 100 with which it is communicatively linked. Server 410 may also collect time profiles of battery usage overlaid with indicators of interesting events or actions that may have been prepared by a computing device element (e.g., overlay generator 124). Server 410 may store the collected data, for example, in a database 430 for analysis by analyzer 420.

Server 410 may collect the foregoing data based upon consent of the computing device users. In some implementations, a user of a computing device may be prompted to explicitly allow data collection. Further, the user may opt in/out of participating in such data collection activities. Furthermore, the collected data may be anonymized prior to collection, storage or analysis.

Analyzer 430, in system 400, may be configured to analyze and correlate battery power draw with events or actions occurring in the computing devices. Analyzer 430 may identify and categorize events or actions according to their effects on battery power draw, for example, on an individual computing device basis. Alternatively or additionally, analyzer 430 may identify and categorize events or actions on a statistical basis according to their effects on battery power draw over several computing devices. Analyzer 430 may be configured to analyze the effects of all events and actions or only particular events and actions (e.g., access of a particular web page, or activation of a particular app) on battery power draw.

System 400 may be further configured to make the analysis by analyzer 430 available to one or more system users. System 400 may provide particular system users (e.g., web developers, app developers) with targeted analysis of battery power draw caused by particular web sites or apps of interest to the system users. Like overlay generator 124 in computing device 100 (FIG. 1), system 400 may be configured to present or display battery power draw profiles or graphs over laid with markers or indicators of interesting events or user actions. System 400 may also be configured to communicate an overlaid power draw profile or graph, in appropriate instances, back to a computing device for display.

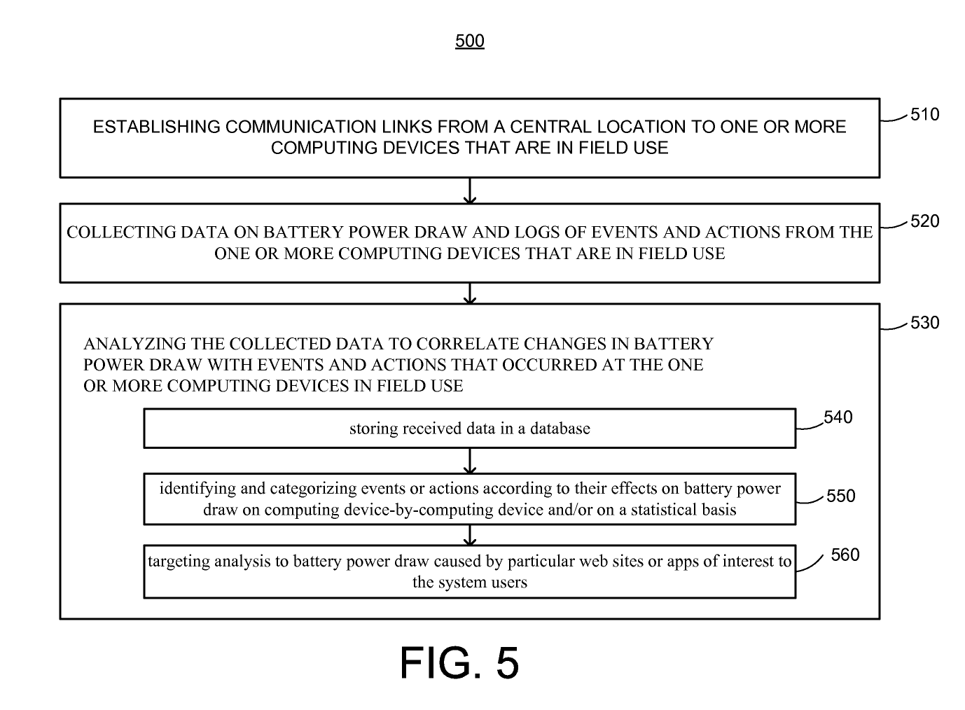

FIG. 5 is a flowchart showing an example method 500 for correlating battery power draw with events or user actions in the operation of one or more computing devices, in accordance with of the principles of aspects described herein. Method 500 illustrated in FIG. 5 may be implemented using system 400 of FIG. 4. Accordingly, description of method 500 herein may include references to system 400. However, it will be appreciated that method 500 may be implemented using other systems or device arrangements, and that method 500 is not limited to system 400 or the specific arrangement of system 400 that is described herein with reference to FIG. 4.

Method 500 includes establishing communication links from a central location to one or more computing devices that are in field use (510), collecting data on battery power draw and logs (i.e., time-stamped records) of events and actions from the one or more computing devices that are in field use (520), and analyzing the collected data to correlate changes in battery power draw with events and actions that occurred at the one or more computing devices in field use (530).

In method 500, establishing communication links from a central location to one or more computing devices that are in field use 510 may include disposing a computer (e.g., a web server or other server) at the central location and establishing web links to the one or more computing devices in field use.

Further in method 500, collecting data from one or more computing devices that are in field use 520 may optionally include collecting time profiles of battery usage that have been previously correlated with events and actions by a computing device in field use (e.g., overlaid with indicators of interesting events or actions by an device element such as generator 124 in computing device 100). Collecting data from one or more computing devices that are in field use 520 may further include storing received data in a database (540).

Additionally in method 500, analyzing the data to correlate changes in battery power draw with the logs (i.e. time-stamped records) of events and actions that occurred at the one or more computing devices 530 may include identifying and categorizing events or actions according to their effects on battery power draw on an individual computing device basis. Alternatively or additionally, analyzing the data to correlate changes in battery power draw with the time-stamped records of events and actions that occurred at the one or more computing devices 430 may include identifying and categorizing events or actions on a statistical basis according to their effects on battery power draw over several computing devices. Further, analyzing the data to correlate changes in battery power draw with the logs (i.e. time-stamped records) of events and actions at the one or more computing devices 530 may include analyzing the effects of all events and actions or only particular events and actions (e.g., access of particular web page, or activation of a particular app) on battery power draw 550).

In method 400, analyzing the data to correlate changes in battery power draw with the time-stamped records of events and actions at the one or more computing devices 430 may include targeted analysis of battery power draw caused by particular web sites or apps of interest to the system users (460).

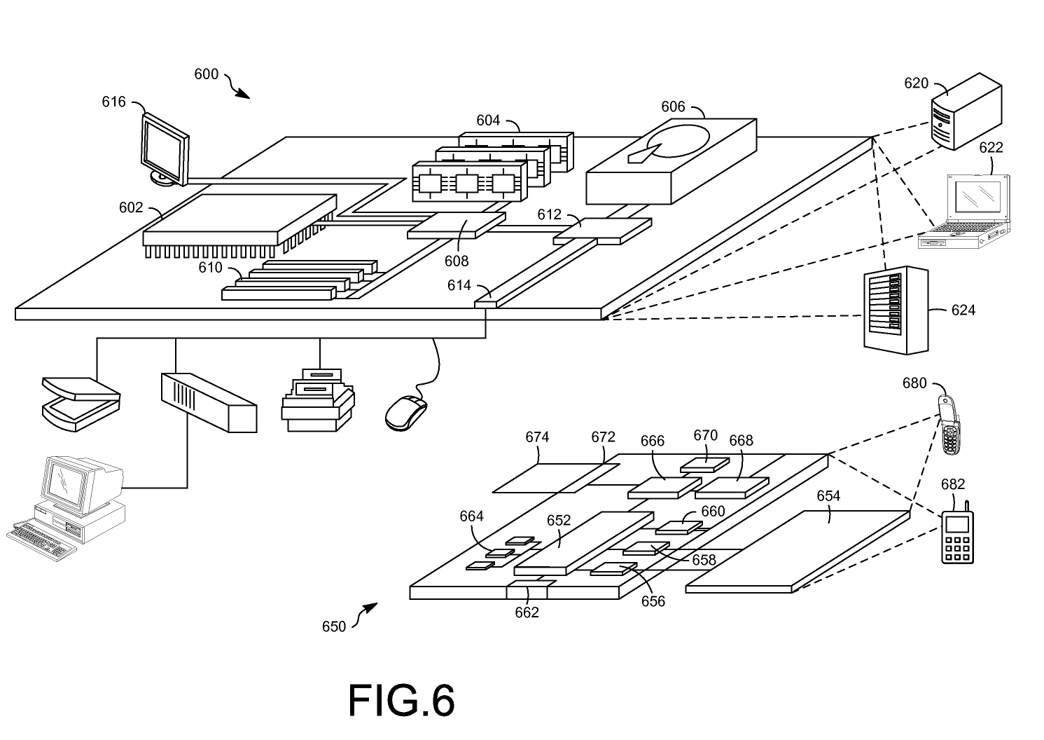

FIG. 6 shows an example of a generic computer device 600 and a generic mobile computer device 650, which may be used with the techniques described here. Computer device 600 is intended to represent various forms of digital computers, such as laptops, desktops, workstations, personal digital assistants, servers, blade servers, mainframes, and other appropriate computers. Computer device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computer device 500 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computer device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computer devices 600 may be connected, with each device providing portions of the necessary operations (e.g., as a server bank, a group of blade servers, or a multi-processor system).

The memory 604 stores information within the computer device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computer device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for computer device 600, while the low speed controller 612 manages lower bandwidth-intensive operations. Such allocation of functions is exemplary only. In one implementation, high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computer device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computer device 600 may be combined with other components in a mobile device (not shown), such as device 650. Each of such devices may contain one or more of computer device 600, 650, and an entire system may be made up of multiple computer devices 600, 650 communicating with each other.

Computer device 650 includes a processor 652, a memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computer device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computer device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

Computer device 650 may be implemented in a number of different forms, as shown in the figure. For example, it may be implemented as a cellular telephone 680. It may also be implemented as part of a smart phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A battery-operated computing device, comprising:
a processor;
a battery monitor configured to provide a time profile of battery power draw in the operation of the computing device;
an event logger configured to record events occurring in the operation of the computing device;
an overlay generator coupled to the battery monitor and the event logger, and configured to generate a graph showing time in a first axis and battery power draw in a second axis with text indicators describing the events at times that the events occurred; and
a display configured to display the generated graph.

2. The computing device of claim 1 that is configured as one of a battery-operated laptop or tablet computer, a digital camera, a personal digital assistant, a mobile phone, a smartphone, and/or a multimedia player.

3. The computing device of claim 1, wherein the overlay generator is further configured to present the graph on the display in the computing device.

4. (canceled)

5. The computing device of claim 3, wherein the overlay generator is programmable and allows designation of events as interesting, and wherein the overlay generator is further configured to overlay the graph with indicators describing the events that have been designated as interesting.

6. The computing device of claim 5, wherein the overlay generator is further configured to highlight events that caused increases in battery power draw above a threshold percent.

7. The computing device of claim 5, wherein the overlay generator is further configured to highlight events that failed to cause increases in battery power draw above a threshold percent.

8. The computing device of claim 1, wherein the battery monitor is further configured to sample battery power draw in the operation of the computer device periodically.

9. The computing device of claim 1, wherein the event logger is programmable, and wherein the event logger is programmed to log computer or application initiated actions and/or user initiated actions during operation of the computing device.

10. The computing device of claim 9, wherein the event logger is programmed to log selected events, and wherein the selected events include one or more of opening or closing of tabs in a web browser, navigating to or away for a particular website, pop-ups, starting or stopping audio, starting or stopping video, transitions between 3G, Wi-Fi, or Ethernet communications, user-triggered or automatic display brightness circuitry responses to ambient light changes, keystrokes, and/or activation or closing of applications.

11. A method, comprising:
in a battery-operated computing device,
collecting data on battery power draw during operation of the computing device;
logging events occurring in the operation of the computing device;
displaying a graph showing time in a first axis and the battery power draw in a second axis; and
overlaying the displayed graph with text indicators describing the logged events at times that the logged events occurred.

12. The method of claim 11, wherein logging events occurring in the operation of the computing device includes recording and time-stamping one or more events occurring in the operation of the computing device.

13. The method of claim 11, wherein displaying a time profile of the battery power draw during operation of the computing device includes displaying the time profile on a display in the battery-operated computing device.

14. The method of claim 11, further comprising, designating particular events in the operation of the computing device as interesting and overlaying the displayed graph with the text indicators at the times that the interesting events occurred during the operation the computing device.

15. The method of claim 14, wherein designating particular events in the operation of the computing device as interesting comprises designating as interesting one or more opening or closing of tabs in a web browser, navigating to or away for a particular website, pop-ups, starting or stopping audio, starting or stopping audio, transitions between 3G, Wi-Fi, or Ethernet communications, user-triggered or automatic display brightness circuitry responses to ambient light changes, keystrokes, and/or activation or closing of applications.

16. The method of claim 11, further comprising, reporting collected battery power draw data and a log of one or more the events to a remote device.

17. A system comprising:
a server configured to receive, from at least a first battery-operated computing device and a second battery-operated computing device, battery power draw data and a log of events occurring at each of the first battery-operated computing device and the second battery-operated computing device in an uncontrolled real use environment based upon consent of users of the first battery-operated computing device and the second battery-operated computing device; and
an analyzer configured to categorize the events according to their effects on the battery power draw on a statistical basis over the first battery-operated computing device and the second battery-operated computing device.

18. The system of claim 17, wherein the first battery-operated computing device and the second battery-operated computing device each include one or more of a battery-operated laptop or tablet computer, a digital camera, a personal digital assistant, a mobile phone, a smartphone, and/or a multimedia player, and wherein the server is configured to be communicatively linked to the first and second battery-operated computing devices via the Internet.

19. The system of claim 17, wherein the analyzer is configured to identify and categorize events according to their effects on battery power draw computing device-by-computing device.

20. (canceled)

21. The system of claim 17, wherein the analyzer is configured to analyze the effects of a selected event on battery power draw.

22. The system of claim 21, wherein the selected event is access of a particular web page or activation of a particular application by a computing device.

23. The system of claim 17, wherein the analyzer is further configured to display battery power draw profiles showing time in a first axis and battery power draw in a second axis, over laid with text indicators describing events at times that the events occurred at the first and second battery-operated computing devices.

24. The system of claim 23, further configured, to communicate the battery power draw profile that occurred at a particular one of the first and second battery-operated computing devices deployed back to the particular computing device for local display.

25. A method, comprising:
at a central location, collecting data on battery power draw and logs of events from at least a first battery-operated computing device and a second battery-operated computing device that are deployed in uncontrolled real use environments, the events including a first designated application and a second designated application; and
categorizing the events according to their effects on the battery power draw on a statistical basis over the first battery-operated computing device and the second battery-operated computing device.

26. The method of claim 25, further comprising, establishing communication links from the central location to the first and second battery-operated computing devices.

27. The method of claim 26, wherein establishing communication links from the central location to the first and second battery-operated computing devices includes disposing a computer at the central location and establishing web links to the computer from the first and second battery-operated computing devices.

28. The method of claim 25, wherein collecting data from the first and second computing devices includes collecting time profiles of battery usage that have been previously correlated with events.

29. (canceled)

30. The method of claim 25, wherein categorizing the events according to their effects on the battery power draw includes analyzing the effects of a selected event, and wherein the selected event is access of a particular web page or activation of a particular application.

31. The method of claim 25, wherein categorizing the events according to their effects on the battery power draw includes analyzing the effects of a selected event, and wherein the selected event is access of a particular web page.

32. (canceled)
